(19) United States
(12) Patent Application Publication
(10) Pub. No.: US 2005/0257068 A1
(43) Pub. Date: Nov. 17, 2005

(54) Method and apparatus for secure issuance of secure firearm identification credentials

(76) Inventor: Francis John Cusack JR., Groton, MA (US)

Correspondence Address: Francis Cusack, 174 Duck Pond Drive, Groton, MA, 01450, US

(21) Appl. No.: 11/079,510

(22) Filed: Mar. 14, 2005

Related U.S. Application Data
(60) Provisional application No. 60/555,043, filed on Mar. 22, 2004.

(51) Int. Cl. H04K 1/00

(52) U.S. Cl. 713/186

(57) ABSTRACT

The invention brings together the components of digital image capture and digital fingerprint capture to both speed up and make more secure the process of applying for a firearm permit and the process of issuing a firearm permit. Biometric data captured, such as face and finger, is used in both verifying the applicant's asserted identity (biometric verification) and in ensuring the applicant is not a member of a group (or database) of individuals who should not be granted a permit (biometric identification). Furthermore, the invention discusses issuing a credential that is inherently more secure than printed and laminated credentials that are ubiquitous today. The invention simultaneously improves service to residents via reduced credential issuance timelines, improves the security of who is issued a firearm credential, and improves the integrity of the firearm credential.

### REFERENCE TO RELATED APPLICATIONS

This application is based on, claims the benefit of the filing date of, and incorporates by reference, the provisional patent application Ser. No. 60/555,043 filed on Mar. 22, 2004.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### BACKGROUND OF THE INVENTION

States throughout the United States have made an admirable effort to sustain high quality service to its resident gun owners in the face of reduced resources and budgets. Many of the current firearm credential systems are labor intensive and inherently insecure. In many states due to the recent need to reduce headcount throughout state government, those responsible for firearm issuance are faced with the challenge of keeping service quality high and license turnaround times low, and to achieve this with a fraction of the workforce previously available.

States and gun owners alike would be better served by a system that provides very fast (even real time) credential issuance, a secure credential that is difficult to compromise or reproduce, and a secure credential issuance to ensure that only authorized citizens are issued firearm permits.

The current firearm issuance process is essentially a manual operation, and therefore in spite of the states' best efforts, is inherently slow to grant law-abiding citizens their firearm credentials. Residents may be required to wait months for their application to be approved, and if their current license expires during the waiting period, they are not permitted to carry firearms in the interim. Technically, these law abiding gun owners are not legally permitted to even have the firearms at their residence during this waiting period.

Furthermore, the credentials issued are often easily compromised or forged. Credentials may not have secure identifiers to accurately match, in a manual or automated manner, the holder with the credential.

The identity verification and assurance that the applicant is not in breach of a condition of ownership (e.g. felon) often consist of only text based checks that are incomplete and by modem standards relatively inaccurate.

The current firearm issuance process typically starts with the applicant presenting himself to the local police department for a photograph and fingerprint. The photographing is often accomplished using outdated and expensive chemical film cameras, which often require capture of multiple photos before one deemed suitable is acquired. As the U.S. Patriot Act has established, the use of face and fingerprints have been selected as the best biometrics for national security. With contemporary systems, the facial data is not digitized or subsequently leveraged for any automated searches, or to enhance existing fingerprint searches.

The fingerprinting is often accomplished by the traditional law enforcement technique of physically rolling the applicant's finger onto an inkpad, and then transferring the print to a paper medium. The paper print is then in turn mailed to a central location, where it is archived. This process is not ideal, as capturing a high quality fingerprint on any medium requires just the right amount of pressure, roll and other subtle dynamics that are not appreciated by law abiding citizens that infrequently submit fingerprints. But the real price is not known until the print is scanned or digitized later in a remote location for comparison to fingerprint databases. Like any automated search system, the quality of the search is only as good as the quality and consistency of the input data. Who can say how many matches will be missed, and how many unnecessary false returns may be processed, due to a search that begins with data captured with 1920's technology?

Finally, the security of the Firearm Identification (FID), License to Carry (LTC) and concealed carry weapon (CCW) credentials is not up to modem standards. The traditional technique of laminating paper produces a credential that often does not remain intact for the term it is valid. Laminated credentials can be easily compromised, and thereby present a risk to law enforcement and a liability to the issuing government.

### BRIEF SUMMARY OF THE INVENTION

The current firearm credential system is based on old technology with many associated deficiencies and liabilities. The invention harnesses secure (including smart) card technology to ensure credential security, and biometrics (e.g. face or finger) operating in either a verification (1:1 search) or identification (1: many) mode, or both to ensure proper credential issuance. The invention simultaneously improves service to residents via reduced credential issuance timelines, improves the security of who is issued a firearm credential, and improves the integrity of the firearm credential.

### BRIEF DESCRIPTION OF THE SEVERAL VIEWS OF THE DRAWING

FIG. 1: Invention Overview with remote printing of secure credential.

FIG. 1a: signature pad

The signature pad is any device to capture the applicant's signature. It may also be connected directly to workstation.

FIG. 1b: face capture device

The face capture device is any device to capture the applicant's face image. May be a conventional camera used in conjunction with a scanner to enter digital face image. Preferred embodiment is a digital still or video camera that interfaces directly to the application workstation. The camera passes either analog video to be digitized at the workstation, or digital still images or digital video to be imported to the application directly.

FIG. 1c: fingerprint capture device

The fingerprint capture device is any device to capture either fingerprint images, or digital representation of fingerprints. Device connects directly to the application server.

FIG. 1d: application workstation

Workstation that supports and facilitates local software applications and functions of applicant enrollment including but not limited to; face capture, fingerprint(s) capture, signature capture and text data capture. Workstation also facilitates secure communication with either local or remote server(s). If the system is configured to work in a purely local fashion, the workstation will also facilitate biometric and text/data based searches.

FIG. 1e: secure data communications

Any form of data, voice or video communications between the workstations(s) and the server.

FIG. 1f: application server

The application server may conduct biometric and text based searches in both verification and identification modes. The server may interface and communicate with other databases and systems to facilitate expanded searches (such as registry of drivers' licenses, out of state firearm credential management systems, and state, local, federal and international law enforcement databases).

FIG. 1g: threat database

The threat database is comprised of demographic and biometric data (e.g. face and/or finger) of individuals that should be denied a credential to bear firearms. This includes but is not limited to local, state (e.g. state police) and federal (e.g. Department of Homeland Security, Department of State, FBI, etc.) known criminals of all levels. It is foreseen that the threat database may also include internationally wanted individuals (e.g. Interpol, international terrorists).

FIG. 1h: credential printer

The credential printer is any printing device to produce the firearm credential. In the preferred embodiment, this may be a card printer capable of producing cards with the latest security technology.

FIG. 1i: secure credential

The secure credential is any credential issued to the applicant that shows his or her right and conditions and restrictions of those rights to possess firearms. In the preferred embodiment, this may be a secure card containing the bearer's face image, demographic data, fingerprint image and details of the specific rights bestowed to the holder. Escort memory such digital memory (as in a smart card) may also be employed to store all of the data in a secure manner. Modem and low cost techniques offer much higher security than laminated products, such as card based credentials. These can be embedded with digital watermarks, holograms, radio frequency (RF) chips and a myriad of other security features that pose a potent deterrent for those inclined to unlawfully produce or modify a credible credential.

FIG. 2: Invention overview with local printing of secure credential.

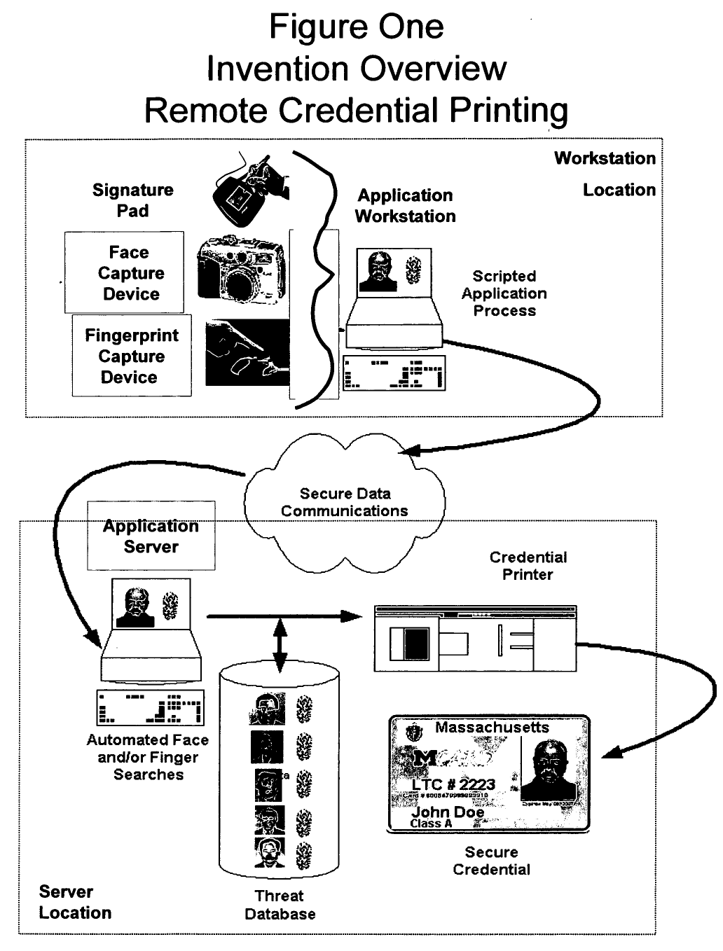

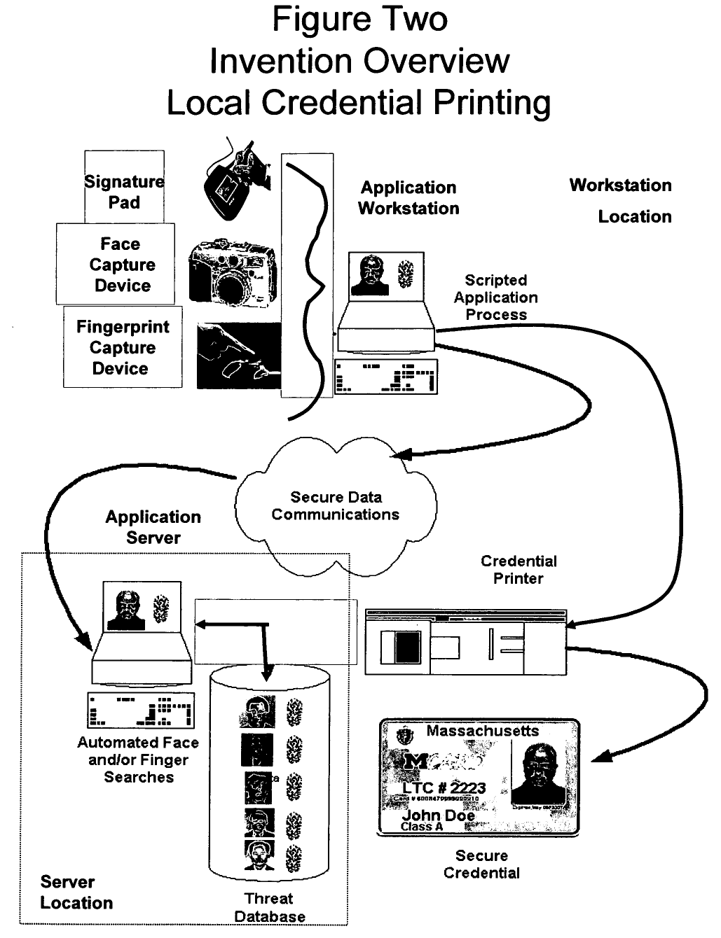

Components of FIG. 2 are defined as per FIG. 1.

### DETAILED DESCRIPTION AND PREFERRED EMBODIMENT OF THE INVENTION

Improved service to residents and law enforcement in the form of decreased timelines, improved credential security and improved issuance security can be realized simultaneously by adoption of a digital semi-automated system. At each permit application location will be installed an enrollment station consisting of a PC with a digital camera, digital fingerprint scanner, digital signature scanner and connectivity to the central administration server via a secure encrypted communication link. In most states the secure infrastructure is already in place.

Local law enforcement personnel will be prompted for data field input by a user friendly and intuitive interface to quickly and accurately capture all personal and demographic data required for the application. This scripted semi automated process will vastly reduce the time that both law enforcement and resident applicants are required to spend on the application or renewal. The applicant will present himself to the digital camera, and the software will assist the operator in taking the best possible digital photograph for both manual and automated identification purposes. The applicant will also submit to the “livescan” digital fingerprint and author a signature on a digital pad.

In real time, the facial and fingerprint biometric data may be sent to the central server for either identity verification (1:1) or identification purposes (1: many). Identity verification may work in cooperation with the states' drivers' license databases. Identity identification may work in cooperation with local, state and federal database of known criminals and threats to national security. In this way, local law enforcement may be altered in real time if the applicant has any state open warrants outstanding (possible today with fingerprints), or if the applicant is deemed a threat to national security (possible today using automated facial recognition). This gives the law enforcement operator excellent situational awareness and provides an opportunity to detain wanted individuals while still within the confines of the police department (assume that is the permit application location).

The biometric data can also be processed off line, and submitted to a comprehensive battery of identification tests to ensure the state does not issue a firearm credential to a known or wanted felon or terrorist. Once the applicant passes all the biometric identification tests, the credential will be printed in a card format by the centrally located card production machine. The credential can then be mailed directly to the individual, or to the issuing police department. Alteratively, the credential could be produced locally at the permit application location, printed in any remote location, or subcontracted to a third party printing company.

All data exchanged between the permit application locations and the central server, and data between permit application locations, is communicated over a secure infrastructure to ensure absolute integrity and security of communications.

### Improved Timeline and Convenience

The time the applicant and the law enforcement operator spend on the application process will be dramatically reduced, affording improved convenience to residents and freeing up law enforcement personnel for more compelling tasks. By virtue of the scripted application process, the operator need only fill out information as requested, with nothing written or printed manually, thereby reducing the risk of human error. Furthermore, by the nature of the digital photo and digital fingerprinting, it is quick and easy to determine if a retake is necessary and can be repeated before the data is archived or used for automated searching. Digital facial images eliminate the need for costly and recurring chemical film stock, and digital fingerprints eliminate the need for messy chemical or ink rolled prints and subsequent scanning.

### Improved Security of Issuance

Because high quality digital fingerprint and facial images are captured during the application, more accurate searches and matches can be conducted against fingerprint and facial databases. Furthermore, in addition to accurate off line matches, real time matches on high threat databases may be conducted in real time providing instant notification to local law enforcement personnel if the applicant is a state or federal threat.

### Improved Credential Security

Cost effective credentials are now available that offer significant improvements in security. Secure cards can be produced for about the same cost as laminated paper credentials. With proven security techniques like digital watermarks, holographic features, and micro-printing, the credentials are essentially tamperproof and not easily forged. Furthermore, card credentials are much more durable than laminated credentials, and will easily remain intact over the period of valid ownership.

### Upgrade and Growth Potential

Once the FID and LTC system described herein is put in place, a number of compelling and powerful enhancements may be considered to increase the thoroughness of validating the applicant's identity assertions.

Systems in place currently do not use real time fingerprint or face biometrics to determine if the applicant has any open warrants. This check may be extended in two important areas. Firstly, with cooperation of the Department of Motor Vehicles, the identity asserted by applicant can be verified through review of the applicants driver's license photo. The license photo may be displayed for manual verification in real time, or automatically verified with facial recognition software.

Secondly fingerprint and facial images can be used to automatically search against FBI most wanted and other publicly available sources of threat information related to Homeland Defense. In this way, the commonwealth may have the peace of mind that no firearm credential will be issued to a known state or federal threat.

1. This invention consists of a system that produces secure credentials and issues credentials in a secure manner for firearm possession which may also be known as concealed carry weapon (CCW), firearm identification (FID), license to carry (LTC) or any related term to denote possession of a firearm, rifle, shotgun, machine gun, etc.

2. The system in claim one uses biometric technology to verify the identity of the applicant IS who the applicant asserts to be, in the preferred embodiment this is realized through face recognition, fingerprint recognition, or both, but any biometric is a candidate.
a. Data of persons to be verified may be any combination of text, image, scanned or biometric data and may reside in local or remote databases.
b. Creation of biometric templates and matching of biometric templates may take place locally or remotely.
c. An operator may assist in the verification process by manually comparing text, image or biometric data.

3. The system in claim one may also use biometric technology to identify the applicant and ensure he is NOT a member of group of that should be denied a firearm permit (e.g. known felon).
a. Data of persons to be denied firearm permits may be any combination of text, image, scanned or biometric data and may reside in local or remote databases.
b. Creation of biometric templates and matching of biometric templates may take place locally or remotely.
c. It is envisioned that multiple databases may be employed to provide ability to search local, state, federal and international databases.
d. An operator may assist in the identification process by manually comparing text, image or biometric data.

4. The system in claim one combines the functionality of two or more of the following to facilitate quick and accurate capture of demographic and biometric data of applicants:
a. A digital camera or camera and scanner that together may produce digital face images
b. Facial recognition biometric software that enrolls, manages and matches faces for automated and manually assisted identity verification and identification.
c. A fingerprint scanner that produces either a fingerprint image or a fingerprint biometric template
d. Fingerprint biometric software that enrolls, manages and matches fingerprints for automated and manually assisted identity verification and identification.
e. A digital signature pad

5. The system in claim one may employ the components of two or more of the following:
a. A workstation to support all of the claims above (4a through 4e), support local enrollment of applicant demographic and biometric data, support application process including pass/fail identity annunciation, presentation of match results, produce reports, facilitate production of firearm credential, support communication with a server that is either collocated or remotely located.
b. A server to support all of the claims above (4a through 4e), support local enrollment of applicant demographic and biometric data, support application process including pass/fail identity annunciation, presentation of match results, produce reports, facilitate production of firearm credential, support communication with a workstation that is either collocated or remotely located, facilitate storing of threat database or communication with external threat databases and other databases that may be deemed helpful to the application and screening process.
c. A credential printer, that may or may not be collocated with any of the other components of the system, that produces the credential to be issued to the applicant.

6. Furthermore, the system of claim 1 can be programmed to manually or automatically search local or remote databases for matching text, numerical and imaged based demographic and/or biometric matches.

7. A secure data communications link or infrastructure may be employed between all components of the system, such as but not limited to; workstation, workstation peripherals (e.g. biometric devices), server and databases.

8. The biometric matching referenced in claim 5 may be achieved with biometric software and biometric templates residing at either each remote location, at the central server, or any combination thereof.

9. The system in claim one may produce a credential to be issued to the applicant that is secure and may employ state of the art security features such as but not limited to ultra-violet (UV) or fluorescent inks, holograms, digital watermarks and encrypted local memory storage (smart card).

10. The credential defined in claim 9 may include text, demographic, image and biometric data of the applicant.
